(19) United States
(12) Patent Application Publication
(10) Pub. No.: US 2025/0086931 A1
(43) Pub. Date: Mar. 13, 2025

(54) METHOD AND APPARATUS WITH NEURAL NETWORK BASED IMAGE PROCESSING

(71) Applicants: Samsung Electronics Co., Ltd., Suwon-si (KR); Korea University Research and Business Foundation, Seoul (KR)

(72) Inventors: Jong-Ok Kim, Seoul (KR); Dong-Keun Han, Seoul (KR)

(73) Assignees: Samsung Electronics Co., Ltd., Suwon-si (KR); Korea University Research and Business Foundation, Seoul (KR)

(21) Appl. No.: 18/821,557

(22) Filed: Aug. 30, 2024

(30) Foreign Application Priority Data
Sep. 7, 2023 (KR) 10-2023-0119149

(51) Int. Cl. G06V 10/60; G06V 10/77; G06V 10/82

(52) U.S. Cl. CPC G06V 10/60; G06V 10/7715; G06V 10/82

(57) ABSTRACT

A method and apparatus with neural network based image processing are provided. The method includes: accessing an input image set including a visible light image of a visible light wavelength band corresponding to an input image and an infrared image of an infrared wavelength band corresponding to the input image; estimating an illumination map representing an illumination configuration of the input image based on a first input image set of the input image set; estimating a confidence score map of the input image based on spectral information of a second input image set of the input image set; and determining illuminant information of the input image by combining the illumination map and the confidence score map.

### CROSS-REFERENCE TO RELATED APPLICATIONS

This application claims the benefit under 35 USC § 119 (a) of Korean Patent Application No. 10-2023-0119149, filed on Sep. 7, 2023, in the Korean Intellectual Property Office, the entire disclosure of which is incorporated herein by reference for all purposes.

### BACKGROUND

### 1. Field

The following description relates to a method and apparatus with neural network based image processing.

### 2. Description of Related Art

Deep learning-based neural networks may be used for image processing. A neural network may be trained based on deep learning, and then perform inference for the desired purpose by mapping input data to output data where the input and output data are in a nonlinear relationship to each other. Such training capability for generating the mapping may be referred to as a learning ability of the neural network. A neural network trained for a special purpose such as image restoration may have a generalization ability to generate a relatively accurate output in response to an input pattern for which it has not been specifically trained for.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an image processing method is performed by one or more processors and includes: accessing an input image set including a visible light image of a visible light wavelength band corresponding to an input image and an infrared image of an infrared wavelength band corresponding to the input image; estimating an illumination map representing an illumination configuration of the input image based on a first input image set of the input image set; estimating a confidence score map of the input image based on spectral information of a second input image set of the input image set; and determining illuminant information of the input image by combining the illumination map and the confidence score map.

The first input image set may include the visible light image, and the second input image set may include the infrared image.

The first input image set and the second input image set may be defined based on first, second, and third dimensions, the first, second, and third dimensions being orthogonal to each other, wherein the illumination map is estimated based on spatial information in the first dimension and the second dimension, and wherein the confidence score map is estimated based on the spectral information in the third dimension.

The second input image set may include multiband images of respective different wavelength bands, and the spectral information may be determined based on a spectral vector having, as vector elements thereof, respective pixel values of corresponding points of the multiband images.

The illumination map may be estimated using a first neural network model, and the confidence score map may be estimated using a second neural network model.

The first neural network model may include: a spatial feature extraction model configured to extract a spatial feature from the first input image set; and an illumination estimation model configured to estimate the illumination map based on the spatial feature.

The second neural network model may include: a spectral feature extraction model configured to extract a spectral feature from the second input image set; and a confidence estimation model configured to estimate the confidence score map based on the spectral feature.

The spectral feature extraction model may be configured to determine the spectral feature of the second input image set by analyzing a context of adjacent bands in the spectral information.

The second input image set may include multiband images of respective different wavelength bands, and the spectral feature extraction model may be configured to analyze a context of a spectral vector based on a recurrent model, and determine the spectral feature by reflecting an analysis result in the second input image set, wherein the spectral vector may have vector elements that are pixel values of corresponding points of the multiband images.

The determining of the illuminant information may include: obtaining a weighted sum between the illumination map and the confidence score map; and determining the illuminant information according to the weighted sum.

The obtaining of the weighted sum may include: weighting vectors in the illumination map according to respectively corresponding confidences in the confidence map and summing the weighted vectors.

The first input image set may include visible light images, including the visible light image, respectively corresponding to different visible light bands, the second input image set may include infrared images, including the infrared image, the spectral information may include a spectral feature map, and the method may further include: inputting the visible light images to a convolutional neural network that infers a spatial feature map therefrom; estimating the illumination map based on the spatial feature map; inputting the infrared images to a recurrent neural network model that infers the spectral feature map therefrom; and the combining the illumination map and the confidence score map may include applying confidence scores in the confidence score map to respectively corresponding illuminant vectors in the illumination map.

In another general aspect, an image processing apparatus includes: one or more processors; and a memory storing instructions configured to cause the one or more processors to: configure an input image set to include a visible light image of a visible light wavelength band corresponding to an input image and an infrared image of an infrared wavelength band corresponding to the input image; estimate an illumination map representing an illumination configuration of the input image based on a first input image set of the input image set; estimate a confidence score map of the input image based on spectral information of a second input image set of the input image set; and determine illuminant information of the input image based on the illumination map and the confidence score map.

The first input image set and the second input image set may be defined based on first, second, and third dimensions, the first, second, and third directions being orthogonal to each other, wherein the illumination map is estimated based on spatial information in the first dimension and the second dimension, and wherein the confidence score map is estimated based on the spectral information in the third dimension.

The second input image set may include multiband images of respective different wavelength bands, and the spectral information may be determined based on a spectral vector having, as vector elements thereof, respective pixel values of corresponding points of the multiband images.

The instructions may be further configured to cause the one or more processors to: estimate the illumination map using a first neural network model; and estimate the confidence score map using a second neural network model.

The second neural network model may include: a spectral feature extraction model configured to extract a spectral feature from the second input image set; and a confidence estimation model configured to estimate the confidence score map based on the spectral feature.

The spectral feature extraction model may be configured to determine the spectral feature of the second input image set by analyzing a context of adjacent bands in the spectral information.

The second input image set may include multiband images of respective different wavelength bands, and the spectral feature extraction model may be configured to analyze a context of a spectral vector based on a recurrent model, and determine the spectral feature by reflecting an analysis result in the second input image set, wherein the spectral vector may gave vector elements that are pixel values of corresponding points of the multiband images.

In another general aspect, an electronic device includes: a camera configured to generate an input image; and one or more processors configured to: access visible light images corresponding to respective visible light wavelength bands; access infrared images corresponding to respective infrared wavelength bands, wherein the visible light images and the infrared images correspond to an input image; estimate an illumination map of the input image based on the visible light images; estimate a confidence score map of the input image based on spectral information of the infrared images, the confidence score map including confidence scores of respectively corresponding illumination vectors in the illumination map; determine illuminant information of the input image based on the illumination map and the confidence score map; and modify pixel values of the input image based on the illuminant information.

Other features and aspects will be apparent from the following detailed description, the drawings, and the claims.

### BRIEF DESCRIPTION OF THE DRAWINGS

FIG. 1 illustrates an example of image processing using a neural network model, according to one or more embodiments.

FIG. 2 illustrates an example of an input image, visible light images, and infrared images, according to one or more embodiments.

FIG. 3 illustrates example structure of a neural network model, according to one or more embodiments.

FIG. 4 illustrates example structure of a first neural network model, according to one or more embodiments.

FIG. 5 illustrates an example of generating a spatial feature using a convolutional model, according to one or more embodiments.

FIG. 6 illustrates example structure of a second neural network model, according to one or more embodiments.

FIG. 7 illustrates an example of generating a spectral feature using a recurrent model, according to one or more embodiments.

FIG. 8 illustrates an example of a white balancing operation using an illuminant vector, according to one or more embodiments.

FIG. 9 illustrates example structure of a confidence score map and an illumination map, according to one or more embodiments.

FIG. 10 illustrates an example of generating visible light images and infrared images using transforming models, according to one or more embodiments.

FIG. 11 illustrates an image processing method, according to one or more embodiments.

FIG. 12 illustrates an example configuration of an image processing apparatus, according to one or more embodiments.

FIG. 13 illustrates an example configuration of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

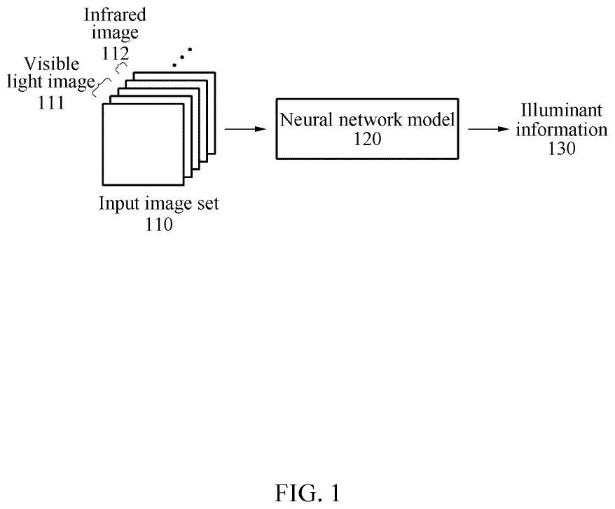

FIG. 1 illustrates an example of image processing using a neural network model, according to one or more embodiments. Referring to FIG. 1, an image processing apparatus may generate illuminant information 130 of an input image set 110 using a neural network model 120. The neural network model 120 may be/include a deep neural network (DNN) including interconnected layers. The layers may include an input layer, at least one hidden layer, and an output layer. Each layer may consist of nodes. The nodes of each layer may be connected to the nodes of an adjacent layer. Connections between nodes may have respective weights that control inferencing outputs, and the weights may be updated by training, for example, by backpropagating loss through the neural network model 120.

The DNN implementing the neural network model 120 may be/include at least a fully connected network (FCN), a convolutional neural network (CNN), and/or a recurrent neural network (RNN). For example, at least some of the layers included in the neural network may correspond to the CNN, and others may correspond to the FCN. The CNN may be referred to as convolutional layers, and the FCN may be referred to as fully connected layers.

In the case of the CNN, data input to any layer may be referred to as an input feature map, and data output from any layer may be referred to as an output feature map. The input feature map and the output feature map may also be referred to as activation data. The input feature map of an input layer may be an image.

The neural network model 120 may be trained based on deep learning and thereby become capable of performing inference suitable for a purpose of the training by mapping input data and output data that are in a nonlinear relationship with each other. Deep learning is a machine learning technique for solving a problem such as image or speech recognition from a big data set. Deep learning may be construed as an optimization problem solving process of finding a point at which energy is minimized while training a neural network using prepared training data.

Through supervised or unsupervised deep learning, a structure of the neural network or a weight corresponding to a model may be obtained, and the input data and the output data may be mapped to each other through the weight. When a width and a depth of the neural network are sufficient, the neural network may have a capacity sufficient to implement a predetermined function. The neural network may achieve an optimized performance by learning a sufficiently large amount of training data through an appropriate training process.

In the following description, the neural network may be represented as being trained “in advance.” Here, being trained “in advance” may mean being trained before the neural network “starts.” That the neural network “starts” may mean that the neural network is ready for inference. For example, that the neural network “starts” may include that the neural network is loaded into a memory, or that input data for inference is input into the neural network after the neural network is loaded into the memory.

The input image set 110 may include a visible light image 111 and an infrared image 112. The visible light image 111 may be generated based on light in the visible spectrum. The infrared image 112 may be generated based on light in the infrared spectrum, e.g., as sensed by an infrared sensor. That is, pixel intensities of the infrared image 112 correspond to intensities of infrared light that was sensed by the infrared sensor. For example, the infrared spectrum may include a near infrared (NIR) wavelength band, or any of the other bands generally considered to be infrared.

The image processing apparatus may use not only the visible light image 111 but also the infrared image 112 to estimate the illuminant information 130. Although NIR light may not be observable by the human eye, NIR light may share some reflection characteristics with visible light, since the NIR band is adjacent/close to the visible light band. The reflection characteristics of NIR light generally vary depending on nature of the surface from which the NIR light has been reflected. In addition, the infrared image 112 may have a robust characteristic in an image capturing environment compared to the visible light image 111. For example, assuming that the visible image 111 and infrared image 112 are images of a same physical scene, because NIR light scatters less than visible light in conditions such as fog and dust, the infrared image 112 may include information or detail (e.g., clarity, depth of scene, etc.) about the scene that is not found in the visible image 111.

The illuminant information 130 may represent an effect of illumination on an input image. For example, the input image may be a visible light color image such as a red, green, and blue (RGB) image. Hereafter, an example in which an RGB image is an input image will be described, but examples are not limited thereto. The illuminant information 130 may include an illuminant vector. When the input image is an RGB image, the illuminant vector may include an R-channel illumination value, a G-channel illumination value, and a B-channel illumination value.

The illuminant information 130 may be applied to a color constancy technology for estimating a color of illumination. For example, one type of color constancy technology—white balancing—may be performed on an input image (e.g., the visible light image 111) by using the illuminant information 130. Due to the intervention of actual illumination, a color of an object in an image generated by a camera may differ from a color of the corresponding actual object. The color constancy technology may reduce or eliminate such an effect of the illumination from the input image. The color constancy technology may part of an image preprocessing process. For example, the color constancy technology may be used in an image processing pipeline.

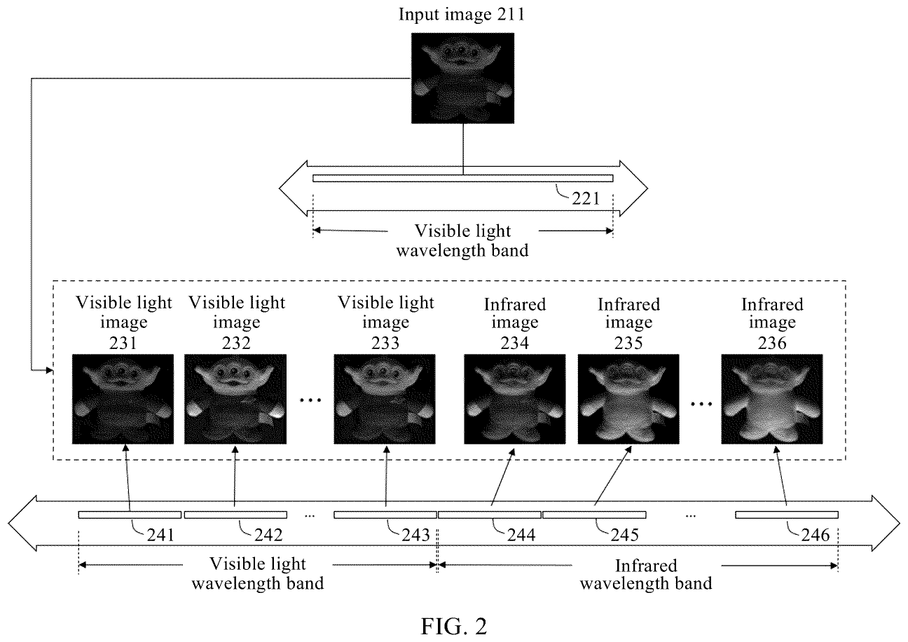

FIG. 2 illustrates an example of an input image, visible light images, and infrared images, according to one or more embodiments. Referring to FIG. 2, an input image 211 may be generated based on light sensed in a full range 221 of the visible light wavelength band. The visible light wavelength band may include a wavelength band of about 400 to 700 nm. Visible light images 231, 232, and 233 may be generated based on partial ranges 241, 242, and 243 of the visible light wavelength band, and infrared images 234, 235, and 236 may be generated based on partial ranges 244, 245, and 246 of the infrared wavelength band. The infrared wavelength band may include a wavelength band of about 700 to 1000 nm. The visible light images 231, 232, and 233 may be referred to collectively as multiband visible light images, the infrared images 234, 235, and 236 may be referred to collectively as multiband infrared images, and the partial ranges 241 to 246 may be referred to collectively as multiband. The visible light images 231, 232, and 233 and the infrared images 234, 235, and 236 may be collectively referred to as multiband images. Multiband sensor(s) or camera(s) may be used for sensing the visible and infrared images.

Widths of the partial ranges 241, 242, and 243 of the visible light images 231, 232, and 233 may be the same as each other. The number of visible light images 231, 232, and 233 will be expressed as M, and the width of the visible light wavelength band will be expressed as B1. In this case, each of the widths of the partial ranges 241, 242, and 243 may each be B1/M. The widths of the partial ranges 244, 245, and 246 of the infrared images 234, 235, and 236 may be the same as each other. The number of infrared images 234, 235, and 236 will be expressed as N, and the width of the infrared wavelength band will be expressed as B2. In this case, each of the widths of the partial ranges 244, 245, and 246 is B2/N. In some implementations, some of the visible and/or the infrared sub-bands may not be adjoining.

The input image 211, the visible light images 231, 232, and 233, and the infrared images 234, 235, and 236 may represent the same physical scene. According to an example, the input image 211 may be generated based on a single sensor for sensing image information of the entire range 221 of the visible light wavelength band. The visible light images 231, 232, and 233 and the infrared images 234, 235, and 236 may be generated based on the input image 211. For example, the visible light images 231, 232, and 233 and the infrared images 234, 235, and 236 may be generated using a neural network. According to another example, the input image 211 may be generated based on a sensor for sensing image information of the visible light wavelength band, the visible light images 231, 232, and 233 may be generated based on at least one sensor for sensing image information of the partial ranges 241, 242, and 243 of the visible light wavelength band, and the infrared images 234, 235, and 236 may be generated based on at least one sensor for sensing image information of the partial ranges 244, 245, and 246 of the infrared wavelength band. In another example, the visible light images 231, 232, and 233 and the infrared images 234, 235, and 236 may be generated based on a sensor capable of sensing both visible and infrared light.

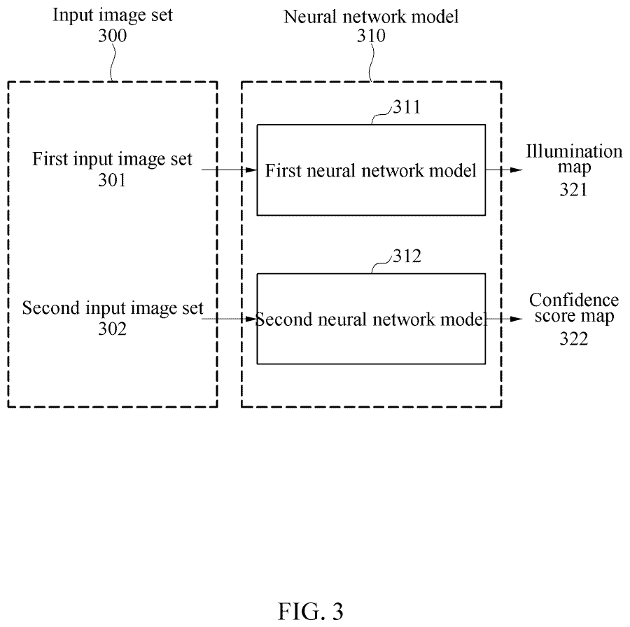

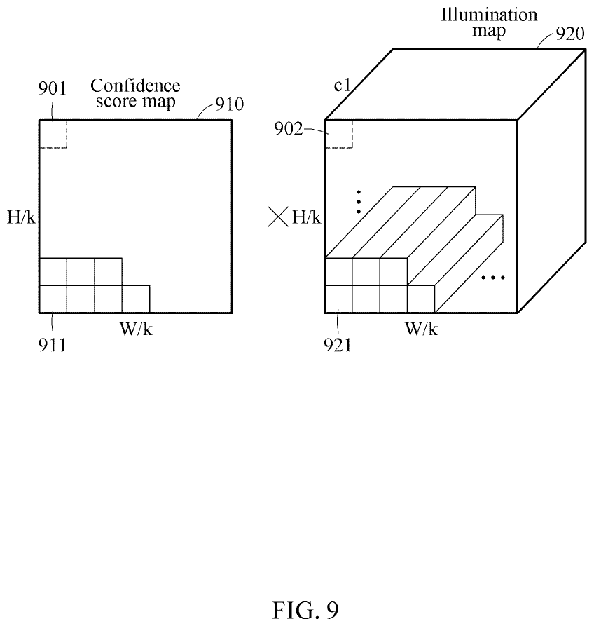

FIG. 3 illustrates an example of a structure of a neural network model, according to one or more embodiments. Referring to FIG. 3, the image processing apparatus may execute a neural network model 310 based on an input image set 300 to estimate an illumination map 321 representing an illumination configuration of an input image and to estimate a confidence score map 322 of the input image. The image processing apparatus may determine illuminant information of the input image (e.g., input image 211) by combining the illumination map 321 and the confidence score map 322, as described with reference to FIG. 9.

According to an example, the image processing apparatus may configure the input image set 300 to include at least one visible light image of a visible light wavelength band corresponding to an input image and at least one infrared image of an infrared wavelength band corresponding to the input image. The image processing apparatus may use a neural network-based transforming model to generate (i) at least one visible light image corresponding to the input image and (ii) at least one infrared image corresponding to the input image (which are in the input image set 300).

The image processing apparatus may estimate the illumination map 321 of the input image based on the first input image set 301, and estimate the confidence score map 322 of the input image based on spectral information of the second input image set 302. The first input image set 301 may include the at least one visible light image, and the second input image set 302 may include the at least one infrared image. For example, the first input image set 301 may be configured with multiband visible light images, and the second input image set 302 may be configured with multiband visible light images and multiband infrared images. Alternatively, the first input image set 301 may be configured with the input image of the visible light wavelength band, and the second input image set 302 may be configured with multiband visible light images and multiband infrared images. Alternatively, the first input image set 301 may be configured with the input image of the visible light wavelength band, and the second input image set 302 may be configured with multiband visible light images.

The first input image set 301 and the second input image set 302 may be defined based on first, second, and third dimensions; the dimensions orthogonal to each other. For example, the first input image set 301 and the second input image set 302 may have dimensions of (H×W×C); H represents a dimension in a height direction, W represents a dimension in a width direction, and C represents a dimension in a channel direction.

The illumination map 321 may be estimated based on spatial information in the first and second directions. Since the image information (e.g., obtained from a sensor) corresponds to spatial information based on the height direction and the width direction, the spatial information may be analyzed based on the first direction and the second direction. The confidence score map 322 may be estimated based on spectral information in the third direction/dimension.

The second input image set 302 may include a volume of multiband visible light images with dimensions of (H×W×M) and a volume of multiband infrared images with dimensions of (H×W×N). In this case, the second input image set 302 may be represented by (H×W×(M+N)) (the input image set 302 may also be referred to as an input volume). As discussed above, M is the number of multibands of the multiband visible light images, and N is the number of multibands of the multiband infrared images. The second input image set 302 may include H*W pixels, and each pixel of the second input image set 302 may include spectral information of the visible light wavelength band and the infrared wavelength band for the same scene. The spectral information may be represented by a spectral vector of 1×1×(M+N). Since the spectral information is based on the channel direction, the spectral information may be analyzed based on the third direction (e.g., along the third dimension of the input volume). The second input image set 302 may include multiband images of different respective wavelength bands. The spectral information may be determined based on a spectral vector having pixel values of corresponding points of multiband images as vector values (e.g., a spectral vector may be the pixels in the multiband images at a same coordinate).

The illumination map 321 may show an illumination configuration for each local area. According to an example, the input image set 300 may include local areas. For example, the first input image set 301 may have dimensions of (H×W×C), and the illumination map 321 may have dimensions of (H/k×W/k×C). Here, k represents a ratio between the two-dimensional (size of the first input image set 301 and the 2D size of the illumination map 321. k may also represent an image downscaling ratio of a neural network model 310. When the first input image set 301 is projected in the channel direction, the projected 2D image may have dimensions of (H×W), and the projected 2D image may include a number of local areas, the number of which is H/k*W/k. Each channel vector of the illumination map 321 in the channel (e.g., band) direction may represent an illumination configuration of a corresponding local area of the 2D image. For example, the illumination configuration may include an illuminant vector. The illuminant vector may include an R channel illumination value, a G channel illumination value, and a B channel illumination value.

The confidence score map 322 may have confidence scores of the illuminant vectors of each of the respective local areas; the location of a confidence score in the confidence score map 322 may correspond to the location of the confidence score's corresponding local area. Each of the multiband images of the second input image set 302 may be represented as a 2D image, and each may include the same number of local areas, namely, H/k*W/k. The first input image set 301 and the second input image set 302 may include corresponding local areas (on a one-for-one basis). The corresponding local areas will be referred to as a corresponding pair. The number of corresponding pairs may be H/k*W/k. The confidence score map 322 may also have dimensions of (H/k×W/k). The confidence score map 322 may include the confidence scores of the respective illuminant vectors of the respective corresponding pairs.

The neural network model 310 may include a first neural network model 311 and a second neural network model 312. The image processing apparatus may estimate the illumination map 321 using the first neural network model 311, and estimate the confidence score map 322 using the second neural network model 312. The image processing apparatus may determine the illuminant information of the input image by combining the illumination map 321 and the confidence score map 322.

Although an “image processing apparatus” is referred to herein as a single device, the features of the embodiments and examples described here vary, and in practice each such variation is a different image processing device. That is, the phrase “the image processing device”, although used repeatedly, does not describe a monolithic device.

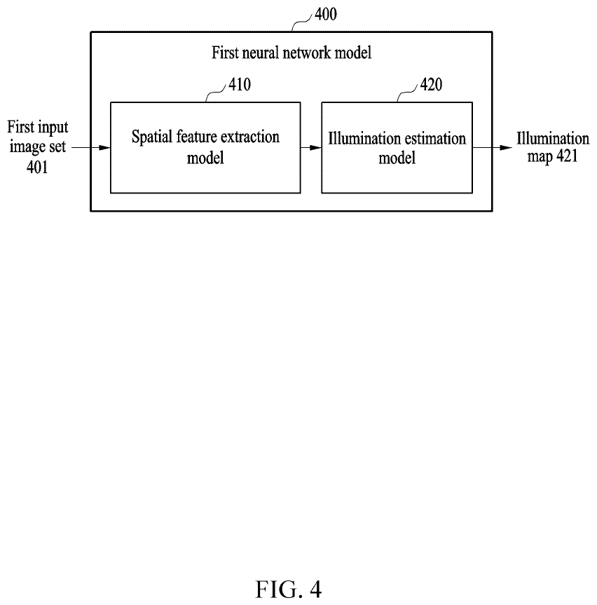

FIG. 4 illustrates example structure of a first neural network model, according to one or more embodiments. Referring to FIG. 4, a first neural network model 400 (e.g., the first neural network model 310) may estimate/predict an illumination map 421 based on a first input image set 401 (e.g., first input image set 301). The first neural network model 400 may include a spatial feature extraction model 410 for extracting a spatial feature from the first input image set 401, and an illumination estimation model 420 for estimating the illumination map 421 (e.g., illumination map 321) based on the spatial feature. The spatial feature extraction model 410 and the illumination estimation model 420 may be implemented as a neural network.

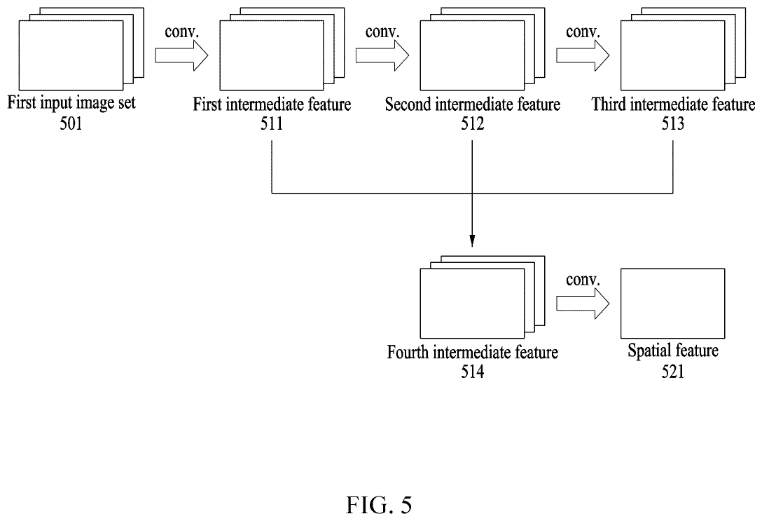

FIG. 5 illustrates an example of generating a spatial feature using a convolutional model, according to one or more embodiments. Referring to FIG. 5, a spatial feature extraction model (e.g., spatial feature extraction model 410) may extract a first intermediate feature 511 from a first input image set 501, extract a second intermediate feature 512 from the first intermediate feature 511, and extract a third intermediate feature 513 from the second intermediate feature 512. The spatial feature extraction model may include convolutional layers, and the convolutional layers may be used to extract the first, second and third intermediate features 511, 512, and 513 (e.g., feature maps). The first input image set 501, the first intermediate feature 511, the second intermediate feature 512, and the third intermediate feature 513 may have the same number of channels. FIG. 5 shows a non-limiting example in which three convolutional layers are used to extract the respective intermediate features 511, 512, and 513.

The first, second, and third intermediate features 511, 512, and 513 may be merged into a fourth intermediate feature 514. For example, with the fourth intermediate feature 514 having pieces of channel data, one piece of channel data thereof may be formed through averaging of the first intermediate feature 511 (e.g., averaging maps therein), another piece of channel data of the fourth intermediate feature 514 may be formed through averaging of the second intermediate feature 512 (e.g., averaging maps therein), and still another piece of channel data of the fourth intermediate feature 514 may be formed through averaging of the third intermediate feature 513 (e.g., averaging maps therein). The pieces may respectively correspond to the channels of the first input image set 501. The spatial feature extraction model may perform a convolution on the fourth intermediate feature 514 to determine a spatial feature 521 of the first input image set 501 (e.g., reducing the multiple channels to one channel).

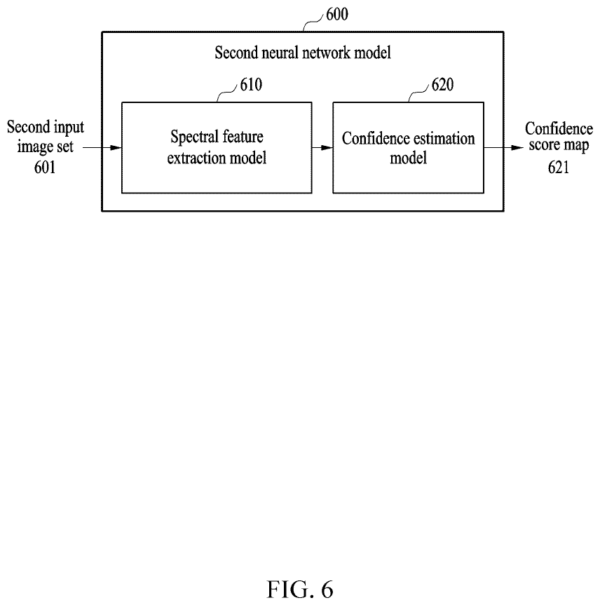

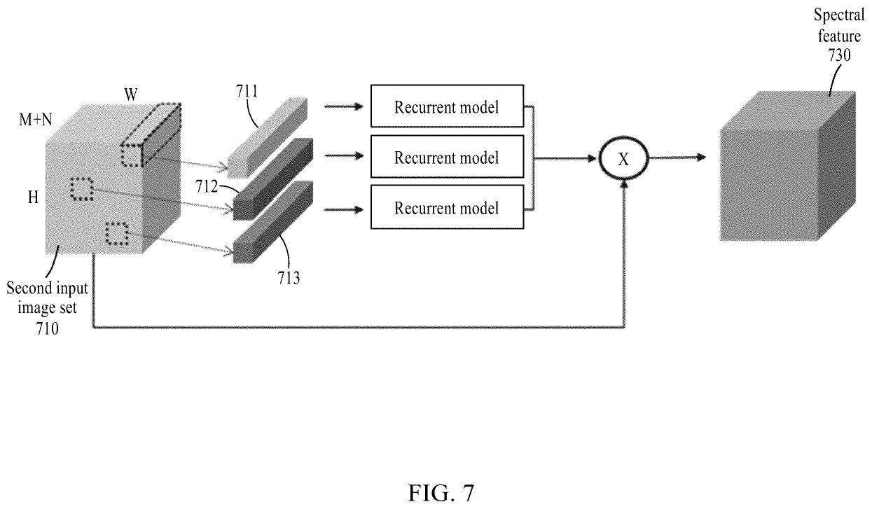

FIG. 6 illustrates example structure of a second neural network model, according to one or more embodiments. Referring to FIG. 6, a second neural network model 600 (e.g., second neural network model 312) may estimate a confidence score map 621 (e.g., confidence score map 322) based on a second input image set 601 (e.g. second input image set 302). The second neural network model 600 may include a spectral feature extraction model 610 for extracting a spectral feature (e.g., spectral feature 730 shown in FIG. 7) from the second input image set 601, and a confidence estimation model 620 for estimating the confidence score map 621 based on the extracted spectral feature. According to an example, when a spatial feature (e.g., spatial feature 521) of the first input image set is extracted by a spatial feature extraction model (e.g., spatial feature extraction model 410), the spatial feature and the spectral feature may be concatenated; the spatial-spectral concatenation may be inputted to the confidence estimation model 620 which may estimate the confidence score map 621 based on the spatial-spectral concatenation. The spectral feature extraction model 610 and the confidence estimation model 620 may be implemented as a neural network.

FIG. 7 illustrates an example of generating a spectral feature using a recurrent model, according to one or more embodiments. Referring to FIG. 7, a second input image set 710 (e.g., second input image set 302) may have dimensions of (H×W×(M+N)) (M and N are as mentioned above). Spectral vectors 711, 712, and 713 may be extracted from the second input image set 710. Here, the term “spectral vector” refers to a vector having, as vector elements, pixel values that correspond to points in the respective multiband images in the second input image set 710 (which may include visible band images and infrared band images). The spectral vectors 711, 712, and 713 may have dimensions of (1×1×(M+N)).

A spectral feature extraction model (e.g., spectral feature extraction model 610) may analyze the spectral vectors 711, 712, and 713 using a recurrent model. The spectral feature extraction model may, (i) based on the recurrent model, analyze a context (next paragraph) of the spectral vectors 711, 712, and 713 having pixel values of corresponding points of multiband images of the second input image set 710 as vector values, and (ii) determine a spectral feature 730 by reflecting an analyzed result on the second input image set 710. The analyzed result may be an analysis result vector having the same dimensions as the spectral vectors 711, 712, and 713, i.e., (1×1×(M+N)). A multiplication (see the “X” in FIG. 7) result may be obtained from multiplication between the analysis result vectors and the spectral vectors 711, 712, and 713. The multiplication result may replace the spectral vectors 711, 712, and 713, or the analysis result vectors may replace the spectral vectors 711, 712, and 713, so that the spectral feature 730 may be determined. The spectral vectors 711, 712, and 713 may be extracted from any points of the second input image set 710. FIG. 7 shows an example in which the three spectral vectors 711, 712, and 713 are used, but examples are not limited thereto.

The spectral feature extraction model may determine the spectral feature 730 of the second input image set 710 by analyzing a context of adjacent bands in spectral information. Adjacent band images among multiband images of the second input image set 710 may have a context according to characteristics of an imaged subject (e.g., a material, reflection characteristics, etc.). The recurrent model may be suitable for analyzing these contexts. As the context of the spectral information is analyzed using the recurrent model, illuminant information close to reality may be derived. The recurrent model may be based on neural network. For example, the recurrent model may include a long short term memory (LSTM). The recurrent model may be implemented as a plurality of models as shown in the example of FIG. 7, or may be implemented as a single model unlike the example of FIG. 7.

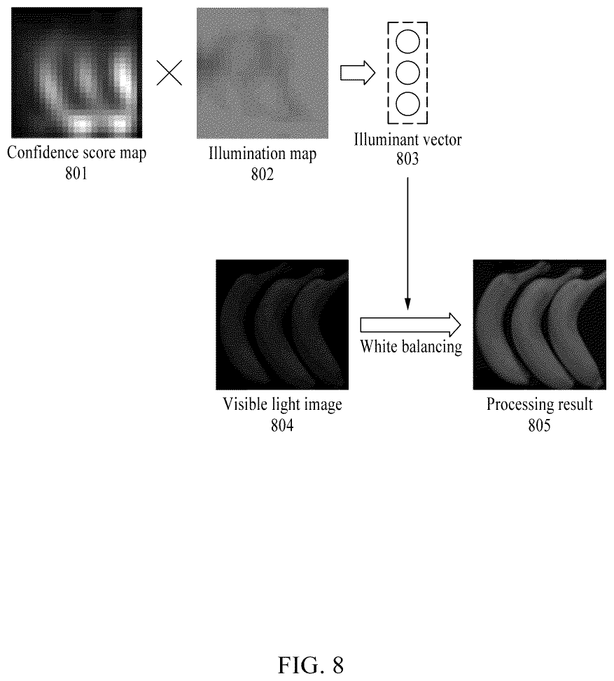

FIG. 8 illustrates an example of a white balancing operation using an illuminant vector, according to one or more embodiments. Referring to FIG. 8, the image processing apparatus may obtain a weighted sum between a confidence score map 801 (e.g., confidence score map 322) and an illumination map 802 (e.g., illumination map 321), and determine illuminant information according to the weighted sum. The weighted sum is described with reference to FIG. 9. For example, the illuminant information may include an illuminant vector 803. The illuminant vector may include an R channel illumination value, a G channel illumination value, and a B channel illumination value. Equation 1 may be used as a loss function.

$$L = {cos}^{- 1} ( \frac{{Γ}_{gt} \cdot {Γ}_{est}}{‖ {Γ}_{gt} ‖ ‖ {Γ}_{est} ‖} ) \qquad Equation 1$$

In Equation 1, L represents a loss, Γₑₛₜ represents an illuminant vector, and Γ_{gt} represents a ground truth (GT). The loss L represents an angular error between the illuminant vector Γₑₛₜ and the GT Γ_{gt}. The illuminant vector 803 may be used for white balancing processing for a visible light image 804. An output image may be determined based on a processing result 805.

FIG. 9 illustrates example structure of a confidence score map and an illumination map, according to one or more embodiments. Referring to FIG. 9, the dimensions of a confidence score map 910 (e.g. confidence score map 322) may be (H/k×W/k). The confidence score map 910 may include local areas such as a local area 901. The number of local areas may be H/k*W/k. The confidence score map 910 may include confidence score values such as a confidence score value 911. The number of confidence score values may be H/k*W/k. The dimensions of an illumination map 920 (e.g., illumination map 321) may be (H/k×W/k×c1). The illumination map 920 may include local areas such as a local area 902. The number of local areas may be H/k*W/k. The local areas 901 and 902 at the corresponding position may be an operation pair. The illumination map 920 may include illuminant vectors such as an illuminant vector 921. The illuminant vector may include an R channel illumination value, a G channel illumination value, and a B channel illumination value (in which case c1 is 3). The number of illuminant vectors may be H/k*W/k.

The image processing apparatus may obtain an illuminant vector (e.g., illuminant vector 803) as a weighted sum, the weighted sum obtained by summing the illuminant vectors of the respective local areas according to the illumination map 920 using confidence scores in the confidence score map 910 as weights. The local areas of the visible light image and the local areas of the infrared image may be corresponding pairs. The confidence score values of the confidence score map 910 may determine (e.g., may be, or be a basis for) the weights for the corresponding pairs. The confidence score and the weight of the corresponding pairs may be determined based on a spectral analysis result, described above. An illuminant vector with dimensions (1×1×c1) (e.g., illuminant vector 803) may be determined through the weighted sum between the illuminant map 920 and the confidence score map 910. Since accuracy of illumination estimation varies depending on a local area of an image, the neural network model may learn reliability of illumination for each area together. One illuminant vector may be determined through the weighted sum according to the reliability of the illumination for each area. The illuminant vector may be used for white balancing of the input image (e.g., the visible light image). To reiterate, the weighted sum (illuminant vector) may be a result of (i) weighting each illuminant vector 921 in the illumination map 920 based on a confidence score at the corresponding location (e.g., same location) in the confidence score map 910, and (ii) summing the weighted vectors.

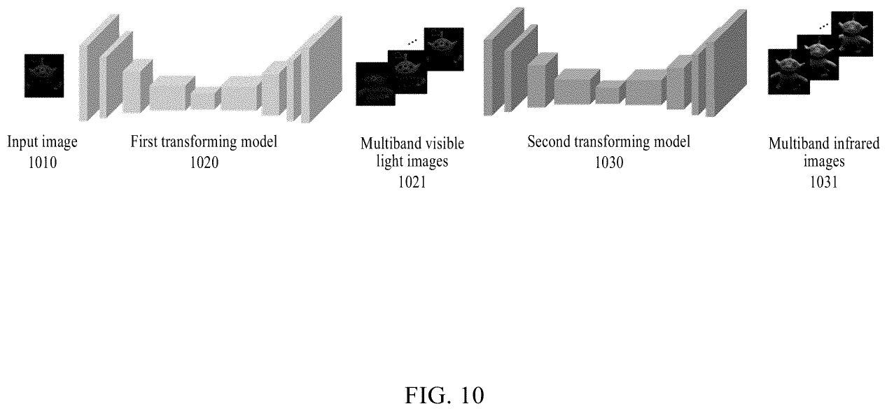

FIG. 10 illustrates an example of generating visible light images and infrared images using transforming models, according to one or more embodiments. Referring to FIG. 10, a first transforming model 1020 may estimate multiband visible light images 1021 according to an input image 1010. A second transforming model 1030 may estimate multiband infrared images 1031 according to the multiband visible light images 1021. The first transforming model 1020 and the second transforming model 1030 may be based on a neural network.

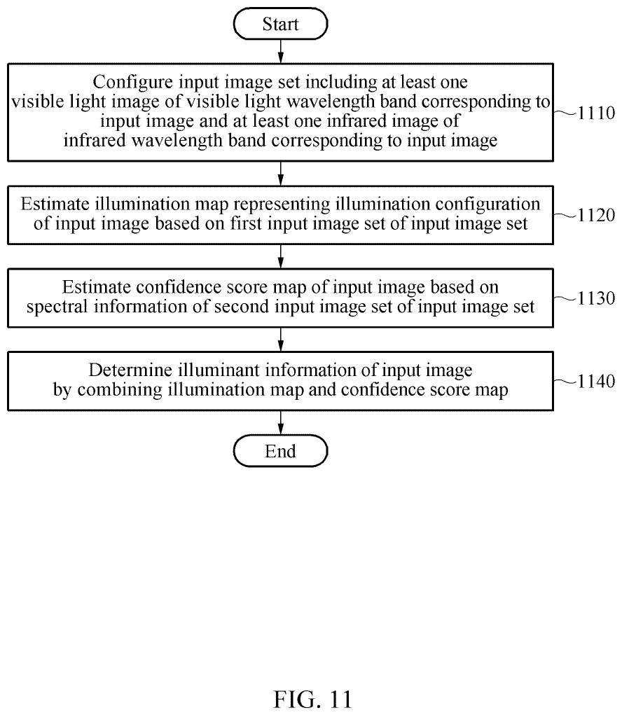

FIG. 11 illustrates an example of an image processing method, according to one or more embodiments. Referring to FIG. 11, the image processing apparatus may (i) configure an input image set including at least one visible light image of a visible light wavelength band corresponding to an input image and at least one infrared image of an infrared wavelength band corresponding to the input image in operation 1110, (ii) estimate an illumination map representing an illumination configuration of the input image based on a first input image set of the input image set in operation 1120, (iii) estimate a confidence score map of the input image based on spectral information of a second input image set of the input image set in operation 1130, and (iv) determine illuminant information of the input image by combining the illumination map and the confidence score map in operation 1140. Here, “spectral information” refers to information derived from images respectively corresponding to different spectrum bands.

The first input image set may include the at least one visible light image, and the second input image set may include the at least one infrared image.

The first input image set and the second input image set may be defined based on the first, second, and third directions orthogonal to each other, the illumination map may be estimated based on the spatial information in the first and second directions, and the confidence score map may be estimated based on the spectral information in the third direction.

The second input image set may include multiband images of different respective wavelength bands, and the spectral information may be determined based on a spectral vector having, as vector elements (values), pixel values of corresponding points of the multiband images.

Operation 1120 may include estimating the illumination map using a first neural network model, and operation 1130 may include estimating the confidence score map using a second neural network model.

The first neural network model may include a spatial feature extraction model for extracting a spatial feature from the first input image set, and an illumination estimation model for estimating the illumination map based on the spatial feature.

The second neural network model may include a spectral feature extraction model for extracting a spectral feature from the second input image set, and a confidence estimation model for estimating the confidence score map based on the spectral feature.

The spectral feature extraction model may determine the spectral feature of the second input image set by analyzing a context of adjacent bands in spectral information.

The second input image set may include multiband images of respective different wavelength bands, and the spectral feature extraction model may analyze a context of a spectral vector having, as vector elements (values), pixel values of corresponding points of the multiband images, may do so based on a recurrent model, and may determine a spectral feature by reflecting an analysis result in the second input image set.

Operation 1140 may include obtaining a weighted sum between the illumination map and the confidence score map, and determining the illuminant information according to the weighted sum.

The weighted sum may be obtained by weighting vectors of the illumination map according to the respectively corresponding confidence scores in the confidence score map and summing the weighted vectors.

The description provided with reference to FIGS. 1 to 10, 12 and 13 is generally applicable to the image processing method of FIG. 11.

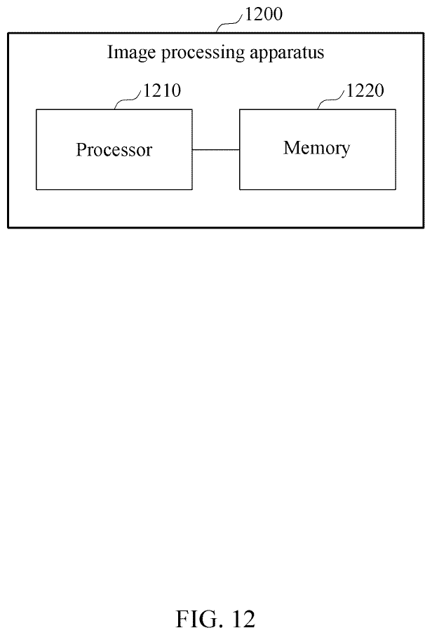

FIG. 12 illustrates an example configuration of an image processing apparatus, according to one or more embodiments. Referring to FIG. 12, an image processing apparatus 1200 may include a processor 1210 and a memory 1220. The memory 1220 may be connected to the processor 1210 and may store instructions executable by the processor 1210, data to be operated by the processor 1210, or data processed by the processor 1210. The memory 1220 may include non-transitory computer-readable media, for example, high-speed random access memory and/or non-volatile computer-readable storage media, such as, for example, at least one disk storage device, flash memory device, or other non-volatile solid state memory device. The processor 1210 may be one, or a combination of, processors, which are described below.

The processor 1210 may execute the instructions to perform the operations of FIGS. 1 to 11 and 13. For example, the processor 1210 may configure an input image set including at least one visible light image of a visible light wavelength band corresponding to an input image and at least one infrared image of an infrared wavelength band corresponding to the input image, estimate an illumination map representing an illumination configuration of the input image based on a first input image set of the input image set, estimate a confidence score map of the input image based on spectral information of a second input image set of the input image set, and determine illuminant information of the input image by combining the illumination map and the confidence score map. In addition, the description provided with reference to FIGS. 1 to 11, and 13 may apply to the image processing apparatus 1200.

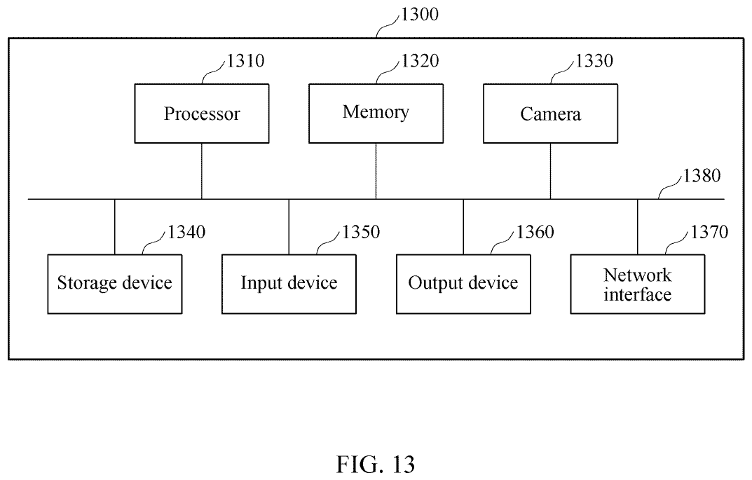

FIG. 13 illustrates an example of a configuration of an electronic device, according to one or more embodiments. Referring to FIG. 13, an electronic device 1300 may include a processor 1310, a memory 1320, a camera 1330, a storage device 1340, an input device 1350, an output device 1360, and a network interface 1370 that may communicate with each other through a communication bus 1380. For example, the electronic device 1300 may be implemented as at least a part of a mobile device such as a mobile phone, a smart phone, a PDA, a netbook, a tablet computer or a laptop computer, a wearable device such as a smart watch, a smart band or smart glasses, a computing device such as a desktop or a server, a home appliance such as a television, a smart television or a refrigerator, a security device such as a door lock, or a vehicle such as an autonomous vehicle or a smart vehicle. The electronic device 1300 may structurally and/or functionally include the image processing apparatus 1200 of FIG. 12.

The processor 1310 may execute functions and instructions for execution in the electronic device 1300. For example, the processor 1310 may process instructions stored in the memory 1320 or the storage device 1340. The processor 1310 may perform the one or more operations described through FIGS. 1 to 12. The memory 1320 may include computer-readable storage media or a computer-readable storage device. The memory 1320 may store instructions to be executed by the processor 1310 and may store related information while software and/or an application is being executed by the electronic device 1300.

The camera 1330 may generate an input image and/or an input image set. The input image may include a photo and/or a video. The camera 1330 may include a visible light camera that generates a visible light image and an infrared camera that generates an infrared image. The visible light image and the infrared imaging may form the input image set. The storage device 1340 may include a computer-readable storage medium or computer-readable storage device. The storage device 1340 may store a larger quantity of information than the memory 1320 for a long time. For example, the storage device 1340 may include a magnetic hard disk, an optical disc, a flash memory, a floppy disk, or other types of non-volatile memory known in the art.

The input device 1350 may receive an input from the user through traditional input manners, such as a keyboard and a mouse, and through newer input manners such as touch, voice, and an image. For example, the input device 1350 may include a keyboard, a mouse, a touch screen, a microphone, or any other device that detects the input from the user and transmits the detected input to the electronic device 1300. The output device 1360 may provide an output of the electronic device 1300 to the user through a visual, auditory, or haptic channel. The output device 1360 may include, for example, a display, a touch screen, a speaker, a vibration generator, or any other device that provides the output to the user. The network interface 1370 may communicate with an external device through a wired or wireless network.

The computing apparatuses, the electronic devices, the processors, the memories, the image sensors, the displays, the information output system and hardware, the storage devices, and other apparatuses, devices, units, modules, and components described herein with respect to FIGS. 1-13 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-13 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An image processing method performed by one or more processors, the method comprising:
accessing an input image set comprising a visible light image of a visible light wavelength band corresponding to an input image and an infrared image of an infrared wavelength band corresponding to the input image;
estimating an illumination map representing an illumination configuration of the input image based on a first input image set of the input image set;
estimating a confidence score map of the input image based on spectral information of a second input image set of the input image set; and
determining illuminant information of the input image by combining the illumination map and the confidence score map.

2. The image processing method of claim 1,
wherein the first input image set comprises the visible light image, and
wherein the second input image set comprises the infrared image.

3. The image processing method of claim 1,
wherein the first input image set and the second input image set are defined based on first, second, and third dimensions, the first, second, and third dimensions being orthogonal to each other,
wherein the illumination map is estimated based on spatial information in the first dimension and the second dimension, and
wherein the confidence score map is estimated based on the spectral information in the third dimension.

4. The image processing method of claim 1,
wherein the second input image set comprises multiband images of respective different wavelength bands, and
wherein the spectral information is determined based on a spectral vector having, as vector elements thereof, respective pixel values of corresponding points of the multiband images.

5. The image processing method of claim 1,
wherein the illumination map is estimated using a first neural network model, and
wherein the confidence score map is estimated using a second neural network model.

6. The image processing method of claim 5, wherein the first neural network model comprises:
a spatial feature extraction model configured to extract a spatial feature from the first input image set; and
an illumination estimation model configured to estimate the illumination map based on the spatial feature.

7. The image processing method of claim 5, wherein the second neural network model comprises:
a spectral feature extraction model configured to extract a spectral feature from the second input image set; and
a confidence estimation model configured to estimate the confidence score map based on the spectral feature.

8. The image processing method of claim 7, wherein the spectral feature extraction model is configured to determine the spectral feature of the second input image set by analyzing a context of adjacent bands in the spectral information.

9. The image processing method of claim 7,
wherein the second input image set comprises multiband images of respective different wavelength bands, and
wherein the spectral feature extraction model is configured to analyze a context of a spectral vector based on a recurrent model, and determine the spectral feature by reflecting an analysis result in the second input image set, wherein the spectral vector has vector elements that are pixel values of corresponding points of the multiband images.

10. The image processing method of claim 1, wherein the determining of the illuminant information comprises:
obtaining a weighted sum between the illumination map and the confidence score map; and
determining the illuminant information according to the weighted sum.

11. The image processing method of claim 10, wherein the obtaining of the weighted sum comprises:
weighting vectors in the illumination map according to respectively corresponding confidences in the confidence map and summing the weighted vectors.

12. The image processing method of claim 1, wherein the first input image set comprises visible light images, including the visible light image, respectively corresponding to different visible light bands, the second input image set comprises infrared images, including the infrared image, the spectral information comprises a spectral feature map, the method further comprising:
inputting the visible light images to a convolutional neural network that infers a spatial feature map therefrom;
estimating the illumination map based on the spatial feature map;
inputting the infrared images to a recurrent neural network model that infers the spectral feature map therefrom; and
the combining the illumination map and the confidence score map comprises applying confidence scores in the confidence score map to respectively corresponding illuminant vectors in the illumination map.

13. An image processing apparatus comprising:
one or more processors; and
a memory storing instructions configured to cause the one or more processors to:
configure an input image set to comprise a visible light image of a visible light wavelength band corresponding to an input image and an infrared image of an infrared wavelength band corresponding to the input image;
estimate an illumination map representing an illumination configuration of the input image based on a first input image set of the input image set;
estimate a confidence score map of the input image based on spectral information of a second input image set of the input image set; and
determine illuminant information of the input image based on the illumination map and the confidence score map.

14. The image processing apparatus of claim 13,
wherein the first input image set and the second input image set are defined based on first, second, and third dimensions, the first, second, and third directions being orthogonal to each other,
wherein the illumination map is estimated based on spatial information in the first dimension and the second dimension, and
wherein the confidence score map is estimated based on the spectral information in the third dimension.

15. The image processing apparatus of claim 13,
wherein the second input image set comprises multiband images of respective different wavelength bands, and
wherein the spectral information is determined based on a spectral vector having, as vector elements thereof, respective pixel values of corresponding points of the multiband images.

16. The image processing apparatus of claim 13, wherein the instructions are further configured to cause the one or more processors to:
estimate the illumination map using a first neural network model; and
estimate the confidence score map using a second neural network model.

17. The image processing apparatus of claim 16, wherein the second neural network model comprises:
a spectral feature extraction model configured to extract a spectral feature from the second input image set; and
a confidence estimation model configured to estimate the confidence score map based on the spectral feature.

18. The image processing apparatus of claim 17, wherein the spectral feature extraction model is configured to determine the spectral feature of the second input image set by analyzing a context of adjacent bands in the spectral information.

19. The image processing apparatus of claim 17,
wherein the second input image set comprises multiband images of respective different wavelength bands, and
wherein the spectral feature extraction model is configured to analyze a context of a spectral vector based on a recurrent model, and determine the spectral feature by reflecting an analysis result in the second input image set, wherein the spectral vector has vector elements that are pixel values of corresponding points of the multiband images.

20. An electronic device comprising:
a camera configured to generate an input image; and
one or more processors configured to:
access visible light images corresponding to respective visible light wavelength bands;
access infrared images corresponding to respective infrared wavelength bands, wherein the visible light images and the infrared images correspond to an input image;
estimate an illumination map of the input image based on the visible light images;
estimate a confidence score map of the input image based on spectral information of the infrared images, the confidence score map comprising confidence scores of respectively corresponding illumination vectors in the illumination map;
determine illuminant information of the input image based on the illumination map and the confidence score map; and
modify pixel values of the input image based on the illuminant information.
